(19) United States
(12) Patent Application Publication
(10) Pub. No.: US 2012/0053952 A1
(43) Pub. Date: Mar. 1, 2012

(54) FLEXIBLE COMPENSATION HIERARCHY

(75) Inventors: Anadi Upadhyaya, Hyderabad (IN); Ty Hayden, Grand Junction, CO (US)

(73) Assignee: ORACLE INTERNATIONAL CORPORATION, Redwood Shores, CA (US)

(21) Appl. No.: 12/873,285

(22) Filed: Aug. 31, 2010

(51) Int. Cl. G06Q 10/00

(52) U.S. Cl. 705/1.1

(57) ABSTRACT

A user interface for modifying a decision-making hierarchy in workplace automation software is described. In an example embodiment, a hierarchy system includes a first electronically represented hierarchy that includes a first set of rules and associations governing interaction of personnel and performance of tasks of an organization. A second electronically represented hierarchy includes a second set of rules and associations that are different from the first set of rules and associations, wherein the second set of rules includes one or more rules governing allotment of compensation to one or more persons of the organization. A first compensation module is adapted to provide a user option to selectively modify the second hierarchy in accordance with one or more privileges associated with the user as defined by the second hierarchy while the system is online. The example flexible hierarchy system further includes one or more machine-readable instructions running on the first compensation module, wherein the instructions are adapted to enable an authorized user to make one or more changes to compensation of a person. Additional instructions facilitate selectively displaying a user interface with one or more controls for enabling an authorized user to move a hierarchy representation of one or more subordinate users to a different position in the hierarchy.

### BACKGROUND

This application relates in general to enterprise applications and more specifically to systems and methods for facilitating documenting and implementing a power structure or decision-making hierarchy within an organization.

For the purposes of the present discussion, an enterprise may be any organization of persons, such as a business, university, government, military, and so on. The terms “organization” and “enterprise” are employed interchangeably herein. A power structure may be any set of rules and/or associations defining authorities or privileges of persons in an organization. Such privileges may, for example, specify tasks, such as allocation of compensation, that may be performed by certain persons.

Organizations are often characterized by a power structure defining roles of participants in the organization. Organizations often demand efficient and user-friendly mechanisms for documenting and enforcing the power structure. Conventionally, an organization may employ written documentation defining the roles of participants, such as employees, managers, and so on. When a person is hired or repositioned within an organization, that person is often assigned a substantially fixed set of privileges, such as decision-making abilities, compensation, and so on, determined by the person's role in the organization or workplace. The fixed privileges are often necessitated by a relatively fixed hierarchy, as organizations often lack the tools to make quick changes to the hierarchy as may be desired.

Conventionally, large businesses may have a Human Resources (HR) department that oversees a single corporate hierarchy. A few HR personnel may be responsible for making various hierarchy-related decisions, such as allotment of salaries, stock options, bonuses, and the allotment of other privileges associated with each position in the business. However, personnel in the HR department may lack awareness as to the day-to-day operations performed by potentially thousands of employees. For example, HR personnel in the United States may be unaware that a particular manager in India has been performing exceptionally and deserves a salary increase or a promotion. Hence, the HR department may lack the ability to make the most informed decisions pertaining to the hierarchy.

To facilitate documenting an organization's hierarchy, certain Enterprise Resource Planning (ERP) software may be employed. An example ERP software application may provide a database for documenting a relatively fixed hierarchy. Certain changes to the ERP-defined hierarchy may require re-coding of the accompanying database and an accompanying restart of the ERP software. This can be time consuming and can disturb business operations. In addition, since hierarchy structures vary widely between organizations, the relatively fixed hierarchies provided by certain ERP software can be impractical for certain organizations. Furthermore, despite use of such software, an HR department may remain ill informed to make important hierarchy-related decisions.

As an organization increases in size, the accompanying hierarchy may become increasingly complicated, further complicating informed HR decision making Furthermore, as a business changes and expands, frequent extensive hierarchy changes may be desirable or necessary. Making informed detailed changes to a hierarchy in real time to meet changing business requirements remains problematic.

### SUMMARY

An example flexible hierarchy system includes a first electronically represented hierarchy that includes a first set of rules and associations governing interaction of personnel and performance of tasks of an organization. A second electronically represented hierarchy includes a second set of rules and associations that are different from the first set of rules and associations, wherein the second set of rules include one or more rules governing allotment of compensation to one or more persons of the organization. A first compensation module is adapted to provide a user option to selectively modify the second hierarchy in accordance with one or more privileges associated with the user as defined by the second hierarchy while the system is online.

The example flexible hierarchy system further includes one or more machine-readable instructions running on the first compensation module, wherein the instructions are adapted to enable an authorized user to make one or more changes to the compensation of a person. Additional instructions facilitate selectively displaying a user interface with one or more controls for enabling an authorized user to move a hierarchy representation of one or more subordinate users to a different position in the hierarchy. The representation of the one or more subordinate users indicates that the one or more subordinate users report directly to the authorized user. A hierarchy representation of the authorizer user represents a manager with managerial privileges associated therewith via the hierarchy.

Additional instructions facilitate displaying a user interface with one or more controls for enabling an authorized user to specify one or more intercept approvers associated with one or more tasks performed by a user of the system. One or more additional controls facilitate enabling a manager to compact one or more levels of the hierarchy that are below the manager. Additional controls facilitate enabling a manager to efficiently request approval of a task from an intercept approver and/or from a superior.

Hence, certain embodiments may enable a manager to adjust compensation of subordinates who report directly to the manager and/or to control hierarchy positioning of subordinates. The manager may be able to make more informed decisions in accordance with a compensation plan as to whether a subordinate deserves a salary adjustment. Without such embodiments, organizations generally lacked the ability to use a separate hierarchy (e.g., separate from an HR hierarchy), such as a compensation hierarchy, to facilitate such informed decision making Instead, organizations often relied upon a few HR personnel to make decisions pertaining to compensation with little or no direct knowledge as to the performance of a worker. Additional flexibility is afforded by user interface controls to facilitate defining intercept approvers/override approvers; controls for selectively communicating approval requests and responses to authorized personal of a hierarchy; controls for enabling authorized users to reposition (or initiate a process to reposition subject to approval) subordinates within a hierarchy, and so on.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram of an example system for implementing a flexible hierarchy according to first embodiment.

FIG. 2 is a flow diagram of a first method adapted for use with the system of FIG. 1 for establishing a compensation hierarchy and accompanying system.

FIG. 3 is a diagram illustrating a first example hierarchy, which may be represented via the system of FIG. 1.

FIG. 4 is a diagram illustrating a second example hierarchy after a manager depicted in the first hierarchy of FIG. 3 makes an example modification to the first hierarchy by moving a subordinate manager and accompanying subordinates.

FIG. 5 is a diagram illustrating a third example hierarchy after a manager depicted in the second hierarchy makes an example modification to the second hierarchy by selectively collapsing a section of the second hierarchy.

FIG. 6 is a diagram illustrating a fourth example hierarchy based on the first hierarchy, but which further illustrates intercept approvers.

FIG. 7 is a first example display that may be represented via the user interface modules of the system of FIG. 1 and that lists certain configurable aspects of an example compensation plan.

FIG. 8 is a second example display for configuring example compensation-plan setup details, wherein the second example display is accessible via the first example display.

FIG. 9 is a third example display for configuring override approvers/intercept approvers for a compensation plan, wherein the third example display is accessible via the first example display.

FIG. 10 is a fourth example display illustrating example compensation plans and accompanying controls and actions available to an authorized manager after login to the system of FIG. 1.

FIG. 11 is a fifth example display illustrating example actions that may be taken by a manager via the fourth example display.

FIG. 12 is a sixth example display illustrating an example worksheet that may appear when a manager selects to allocate rewards from the fifth example display.

FIG. 13 is a seventh example display illustrating example actions that may be taken or triggered by a manager via the sixth example display.

FIG. 14 is an eighth example display illustrating an example dialog box that appears when a manager chooses to assign a worker to another manager via the seventh example display.

FIG. 15 is a flow diagram of a second example method adapted for use with the system of FIG. 1 and the user interface displays of FIGS. 7-14.

FIG. 16 is a flow diagram of a third example method adapted for use with the system of FIG. 1 and the user interface displays of FIGS. 7-14.

### DETAILED DESCRIPTION OF EMBODIMENTS

Although the description has been described with respect to particular embodiments thereof, these particular embodiments are merely illustrative, and not restrictive.

For example, while certain embodiments are discussed with reference to a compensation hierarchy, embodiments are not limited thereto. For example, various user interfaces, modules, methods, and functionality described herein may readily be adapted to different types of hierarchies without departing from the scope of the present teachings.

For clarity, certain well-known components, such as hard drives, operating systems, routers, power supplies, and so on, have been omitted from the figures. However, those skilled in the art with access to the present teachings will know which components to implement and how to implement them to meet the needs of a given application.

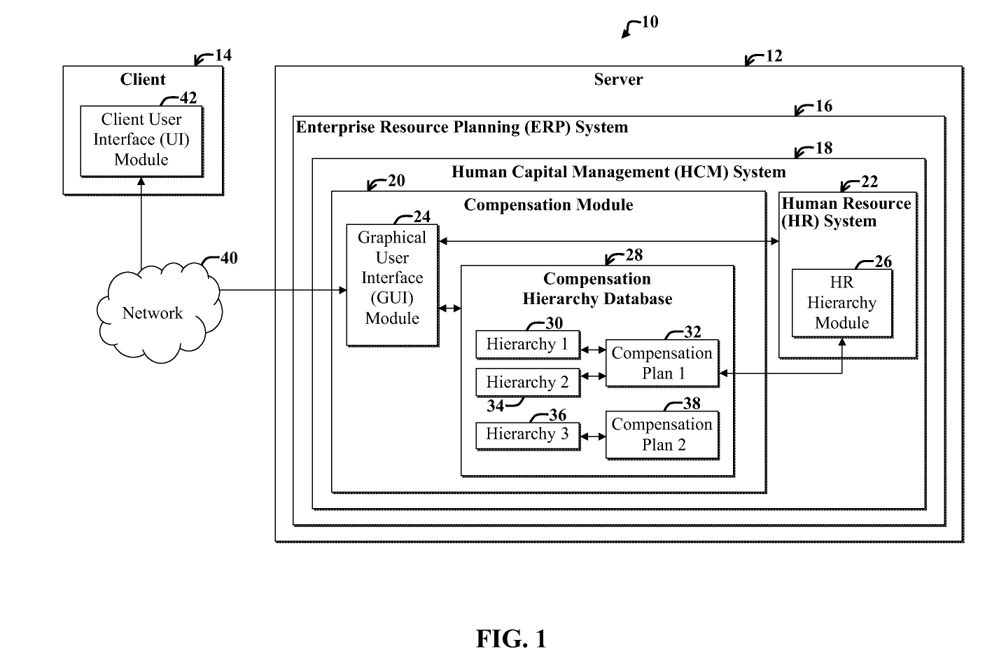

FIG. 1 is a diagram of an example system 10 for implementing a flexible hierarchy according to first embodiment. The example system 10 includes a server 12 running an Enterprise Resource Planning (ERP) application that includes a Human Capital Management (HCM) system 18. The HCM system 18 is adapted to include a compensation module 20 in communication with a Human Resource (HR) system 22. The compensation module 20 includes a compensation hierarchy database 28 in communication with a Graphical User Interface (GUI) module 24. For illustrative purposes, the compensation hierarchy database 28 is shown further communicating with an HR hierarchy module 26 running on the HR system 22.

For illustrative purposes, the compensation hierarchy database 28 is shown including a first hierarchy 30 and a second hierarchy 34 for allotting compensation according to a first compensation plan 32. A third hierarchy 36 facilitates allocating compensation according to a second compensation plan 38. Note that more or fewer electronically represented hierarchies may be implemented via the compensation hierarchy database 28 than those shown. Furthermore, the associations between hierarchies 30, 34, 36 and compensation plans 32, 38 shown in FIG. 1 are merely illustrative. For example, the first hierarchy 30 and the second hierarchy 34 may be associated with separate compensation plans.

In an example implementation, third hierarchy 36 represents a power structure for determining how and by whom salaries of workers may be adjusted or determined. The second compensation plan 38 represents a salary compensation plan 38 specifying desired compensation rules for structuring the hierarchy 36 and determining functionality afforded to users of the system 10 to modify the third hierarchy 36. Similarly, the first compensation plan 32 may pertain to the allotment of bonuses and awards, such as stock grants, year-end bonuses, and so on. The first hierarchy 30 may represent a hierarchy for personnel, such as managers, to allot bonuses to workers, while the second hierarchy 34 may pertain to the allotment of stocks and options to employees. Hierarchies and associated compensation plans may vary among organizations using the system 10.

Functionality enabling an organization, such as a business, to adjust or manipulate hierarchies and associated compensation plans maintained by the compensation hierarchy database 28 is incorporated in GUI module 24. A user may log directly into the GUI 24 via the computer system associated with the server 12. Alternatively, a user, such as a manager, may employ a client 14 and accompanying client User Interface (UI) module 42 to log into the system 10 and to access functionality afforded by the compensation module 20. The client UI 42 may be implemented via a browser. Alternatively, or in addition, certain server-side functionality and software, such as software represented by the GUI module 24, may be implemented on the client UI module 42, without departing from the scope of the present teachings. The client 14 may communicate with the server 12 via a network 40, such as a Local Area Network (LAN), Wide Area Network (WAN), the Internet, and/or other network.

In the present example embodiment, the hierarchies 30, 34, 36 represent compensation hierarchies. For the purposes of the present discussion, a compensation hierarchy may include any power structure defining powers or privileges of personnel to make compensation-related decision for an organization. The compensation-related decisions may include, for example, personnel salaries, bonuses, stock allocations, vendor payments, product/service procurement payments, and so on. The hierarchy representation may be considered to include the fund allotments (e.g., salaries, bonuses, etc.) themselves. The term “compensation” may refer to any fund allotment made or to be made by an organization, such as a business.

In operation, an administrator may log into the compensation module 20 to set up the compensation hierarchy database 28 by defining initial hierarchies, associating hierarchies with compensation plans, developing any necessary compensation plans, and so on. Once the compensation hierarchy database 28 is setup, personnel, such as managers, that have been authorized (via the initial setup) to access the compensation hierarchy database 28 may login to the database 28 via the client 14 and GUI module 24.

A given user, such as a manager, that logs into the system 10 via a login interface screen will have an initial set of privileges associated therewith. When a user logs into the system 10, the user supplies login information, which is associated with the user's privileges. The privileges associated with a particular user may specify, for example, that the user may have access to tools to adjust compensation for one or more subordinates and/or that the user may have further access to tools to adjust the hierarchy structure itself, such as by moving representations of subordinates into different positions in the hierarchy, as discussed more fully below. For example, an authorized user may reassign a supervisory role of a first person to a second person. The supervisory role may include compensation decision-making authority for one or more subordinates of the first person.

An administrator that logs into the system 10 may have ultimate authority, such as to change compensation allotment rules or plans to be enforced by the organization; to assign override approvers to certain tasks performed by certain managers; or to otherwise the change the entire set of hierarchies 30, 34, 36, 26 of the organization. For the purposes of the present discussion, an intercept approver may be any person, or electronic hierarchy representation of the person, of an organization that is granted authority to approve one or more predetermined types of decisions made by one or more persons specified in a hierarchy of the organization. An intercept approver is said to intercept a portion of a hierarchy. The intercept approver may lack other direct supervisory privileges over a particular manager or worker other than approving or denying decisions made by the manager or worker pertaining to a given task or tasks.

For the purposes of the present discussion, a manager may be any person of an organization that has privileges to control activities, compensation, or other privileges associated with another person of an organization. For example, a manager may have other managers and/or employees that report to them, i.e., direct subordinates, and the manager may have the authority or privilege enabling the manager to make salary adjustments, bonus allotments, position reassignments, and other adjustments to the privileges of the directly subordinate managers or employees. A manager may have access to performance ratings and work submitted by subordinates, which may enable a manager to make more informed compensation-related decisions.

In an example operative scenario, an organization employing the system 10 will enable various project managers, also called line managers, that oversee particular projects or groups, to make certain compensation adjustments pertaining to subordinate workers. This enables better-informed decision making, as managers may have better knowledge as to the performance of direct subordinates than HR personnel.

For the purposes of the present discussion, a line manager may be any person within an organization that oversees a particular group of one or more other persons in the organization but that is distinct from personnel of a Human Resources department of the organization.

For the purposes of the present discussion, changes to a workers salary are considered to represent changes to a hierarchy, since a salary level associated with a given worker represents a privilege associated therewith. Similarly, changes to a power structure itself, such as those made by changing the supervisors of certain workers, are also considered to represent hierarchy changes.

Note that the terms “hierarchy” and “electronic representation of a hierarchy” are employed interchangeably herein. In practice, the electronic representation of a hierarchy should substantially conform to the actual hierarchy of the organization/business. The system 10, including the compensation module 20, includes mechanisms for facilitating enforcement of the electronic representations of the hierarchies 30, 34, 36. In particular, when a changes is made to an electronic representation of a hierarchy, notifications are sent via the GUI module 24 to appropriate personnel to facilitate enforcement, as discussed more fully below.

Note that the hierarchies 30, 34, 36 that are maintained by the compensation hierarchy database 28 may coexist with the HR hierarchy 26. The HR hierarchy 26 may be entirely separate from the parallel hierarchies 30, 34, 36. Alternatively, the HR hierarchy 26 may interface with the hierarchies 30, 34, 36 of the compensation hierarchy database 28. Such an interfacing may occur when, for example, personnel from an HR department, as represented in the HR hierarchy module 26, act as override approvers (also called intercept approvers) for tasks performed by personnel represented in the hierarchies 30, 34, 36.

The HR hierarchy module 26 may include an electronic representation of a corporate power structure (represented in a hierarchy) that is used by an HR department of an organization that employs the system 10. For the purposes of the present discussion, the hierarchy used by the HR department and maintained by the HR hierarchy module 26 represents a different hierarchy than the compensation hierarchies 30, 34, 36 maintained by the compensation hierarchy database 28, although information pertaining to the different hierarchies may be propagated between personnel represented in the different hierarchies.

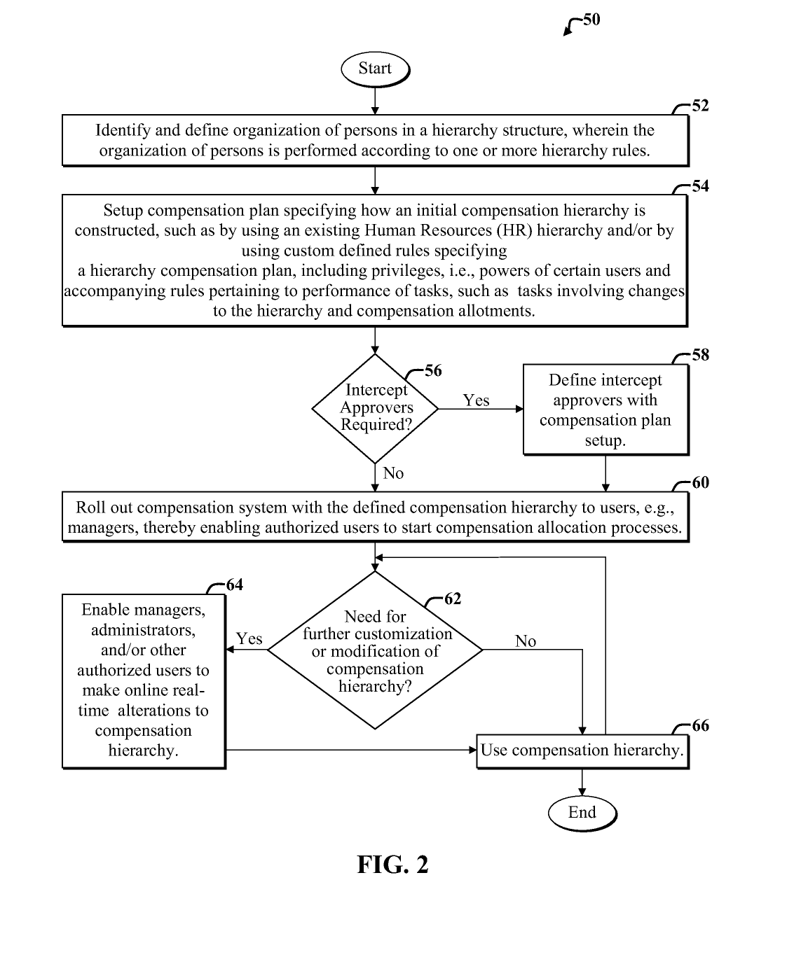

FIG. 2 is a flow diagram of a first method 50 adapted for use with the system 10 of FIG. 1 for establishing a compensation hierarchy and accompanying compensation system. The example method 50 may be performed by an administrator and/or other authorized personnel. The method 50 includes an initial identification step 52, which includes identifying and defining a hierarchy structure that specifies how representations of persons are organized in a power structure. The power structure, i.e., organization of persons in the hierarchy, is structured in accordance with one or more hierarchy rules. The hierarchy rules may specifying who will report to whom, i.e., which personnel will be subordinates of certain other personnel.

Subsequently, a compensation-plan setup step 54 is performed. The compensation-plan setup step 54 includes specifying how an initial compensation hierarchy will constructed. For example, the setup may specify that the compensation hierarchy will use an existing Human Resources (HR) hierarchy or that the compensation hierarchy will be based on a different hierarchy specified by rules determined in the initial identification step 52. The rules may further specify how tasks and privileges are allocated, such as tasks and privileges involving changes to the hierarchy and compensation allotments.

Next, an intercept-approver-checking step 56 is performed. The intercept-approver-checking step 56 includes determining if any intercept-approvers are required or desired. If intercept approvers are to be added, then an intercept-approver-defining step 58 is performed. In the intercept-approver-defining step 58, intercept approvers are defined with reference to a compensation plan. If no intercept approvers are to be added, or any necessary or desired intercept approvers are defined in the intercept-approver-defining step 58, then a rollout step 60 is performed.

The roll-out step 60 includes running the resulting compensation system and rolling out access to the compensation system to authorized users, such as managers, thereby enabling the authorized users to begin compensation allocation tasks and processes and other hierarchy adjustment tasks.

After the hierarchy compensation system is rolled out, a customization-checking step 62 is performed. The customization-checking step 62 involves determining if any customization or modification to the compensation hierarchy is needed. If further customization or modification is needed, then a user modification step 64 is implemented.

The user-modification step 64 includes enabling managers, administrators and/or other authorized personnel to make real-time online alterations to the compensation hierarchy while the compensation system is running. After any necessary modifications are implemented or enabled, users resume using the hierarchy compensation system with the new compensation hierarchy in a using step 66. If while users are using the system at step 66 the users determine that hierarchy modifications are needed, the user-modification step 64 may be performed in real time while the users continue to use the compensation system and the most recently updated hierarchy.

For the purposes of the present discussion, a system is said to be online if it is running and available for use by one or more persons that have access privileges to use the system.

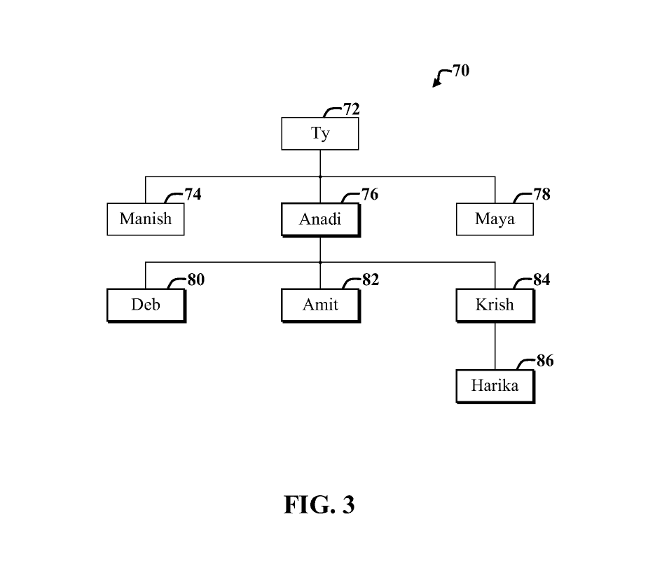

FIG. 3 is a diagram illustrating a first example hierarchy 70, which may be represented via the system 10 of FIG. 1. The example hierarchy 70 may be represented, for example, by one of the hierarchies 30, 34, 36 of the compensation hierarchy database 28 shown in FIG. 1.

The present example hierarchy includes a representation of first manager 72 named Ty. Ty's direct subordinates include a second manager 74 named Manish, a third manager 76 named Anadi, and a fourth manager 78 named Maya. Anadi's direct subordinates include a fifth manager 80 named Deb, a sixth manager 82 named Amit, and a seventh manager 84 named Krish. Krish's direct subordinate includes an eight manager 86 named Harika.

Ty is said to currently have compensation-decision making authority over Manish 74, Anadi 76, and Maya 78. Ty 72 may also have other authorities over subordinates as specified by additional rules included in an associated compensation hierarchy or rules included in a separate parallel hierarchy, such as an HR hierarchy.

For the purposes of the present discussion, decision-making authority of a person, such as a manager, may be any privilege associated therewith that defines one or more powers to direct one or more operations of an organization, wherein the one or more operations may include tasks performed by subordinates of the person. In the present example, managers have direct decision-making authority over direct subordinates pertaining to compensation decisions. Managers have further decision-making authority over the relative positions of directly subordinate managers or representations thereof in the compensation hierarchy. A first manager is said to be directly subordinate to a second manager if the second manager reports directly to the first manager, where the first manager has predetermined authority over one or more tasks or decisions of the second manager.

For the purposes of the present discussion, a subordinate of a person, such as a manager, may be any person within an organization that directly reports to the person. The person is often called the boss of the subordinate.

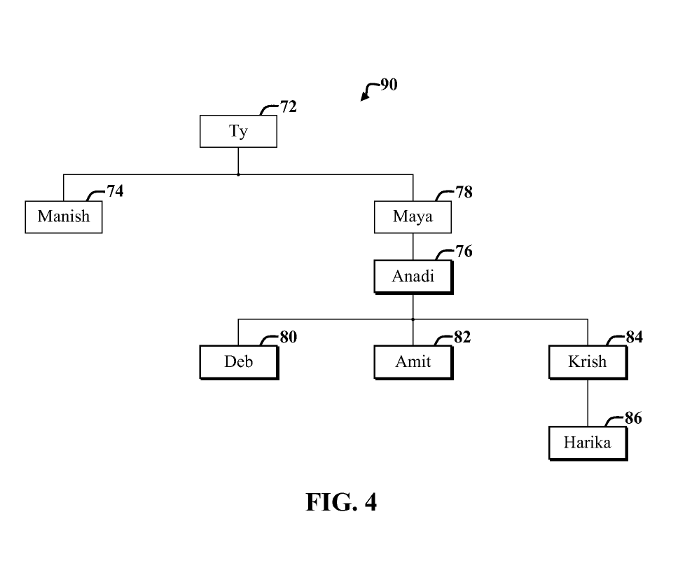

FIG. 4 is a diagram illustrating a second example hierarchy 90 after the first manager 72, i.e., Ty 72, makes an example modification to the first hierarchy 70 by moving a subordinate manager Anadi 76, and accompanying subordinates 80-86. Ty has employed the client 14 to display screens generated by the GUI module 24 of FIG. 1 to initiate moving his subordinate Anadi 76 and accompanying subordinates 80-86 such that Anadi 76 now reports to Ty's subordinate Maya 78. Anadi's section of the compensation hierarchy 90 now appears under Maya 78.

Hence, managers, such as those depicted in FIG. 4, can use the compensation system 10 of FIG. 1 to move one or more persons alone within a hierarchy and to move sections of the hierarchy to different positions within the hierarchy. The compensation module 20 also includes computer-readable instructions adapted to enable an authorized manager to selectively collapse sections of a hierarchy, as discussed more fully below.

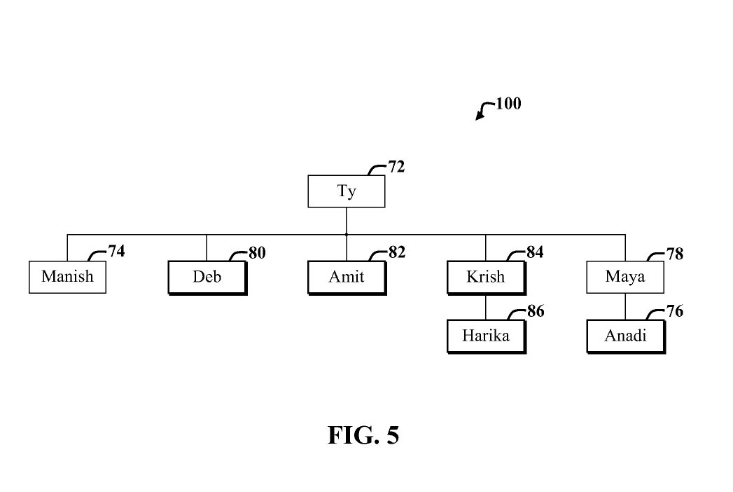

FIG. 5 is a diagram illustrating a third example hierarchy 100 after manager Ty 72 makes an example modification to the second hierarchy 100, via the compensation hierarchy module 20 of FIG. 1, by selectively collapsing, i.e., compacting a section of the second hierarchy. The collapsed section corresponds to the section that includes Anadi 76 and subordinates 80-86. In particular, the subordinates 80-86 of Anadi 76 are moved up two levels such that Deb 80, Amit 82 and Krish 84 now report directly to Ty 72 instead of Anadi 76. Anadi 76 continues to report to Maya 78.

For the purposes of the present discussion, a manager is said to compact or collapse one or more levels of the hierarchy when the manager adjusts the hierarchy so that a subordinate of a subordinate of the manager is moved such that they directly report to the manager. Ty 72 is said to have managerial privileges, as Ty can initiate adjustments to the compensation of subordinates 74-86 and can adjust portions of the hierarchy 100 below Ty.

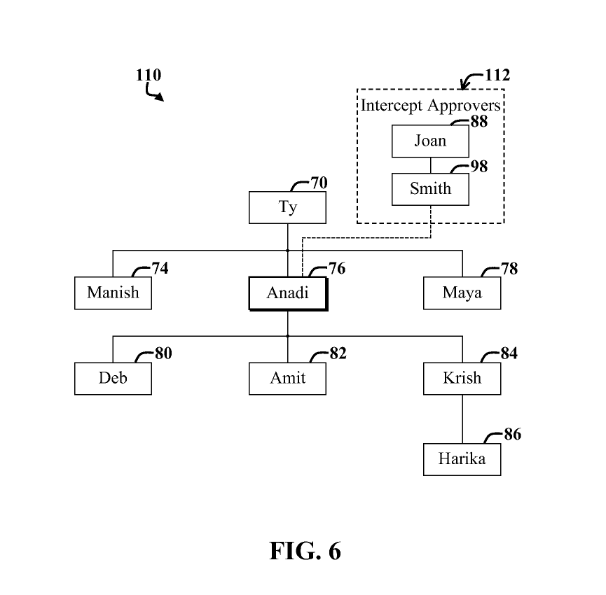

FIG. 6 is a diagram illustrating a fourth example hierarchy 110 based on the first hierarchy 70 of FIG. 1, but which further illustrates example intercept approvers 112. The intercept approvers 112 include Smith 98 and Joan 88. In the present example, Joan 88 and Smith 98 must approve changes to the compensation hierarchy, such as movement of managers and tasks involving allocation of compensation, that are performed by Anadi 76. Ty 70 retains authority to move Anadi 76 within the hierarchy 110 and to adjust Anadi's compensation. As Anadi 76 is moved in the hierarchy 110, the intercept approvers 112 may move with Anadi 76 unless an administrator or other authorized personnel use the compensation 10 of FIG. 1 to remove or adjust the intercept approvers 112.

The ability of an organization to move intercept approvers within a hierarchy representation (that is enforced and communicated among personnel of an organization, e.g., by the system 10 of FIG. 1) provides added flexibility of an organization to oversee and govern tasks performed by personnel of the organization.

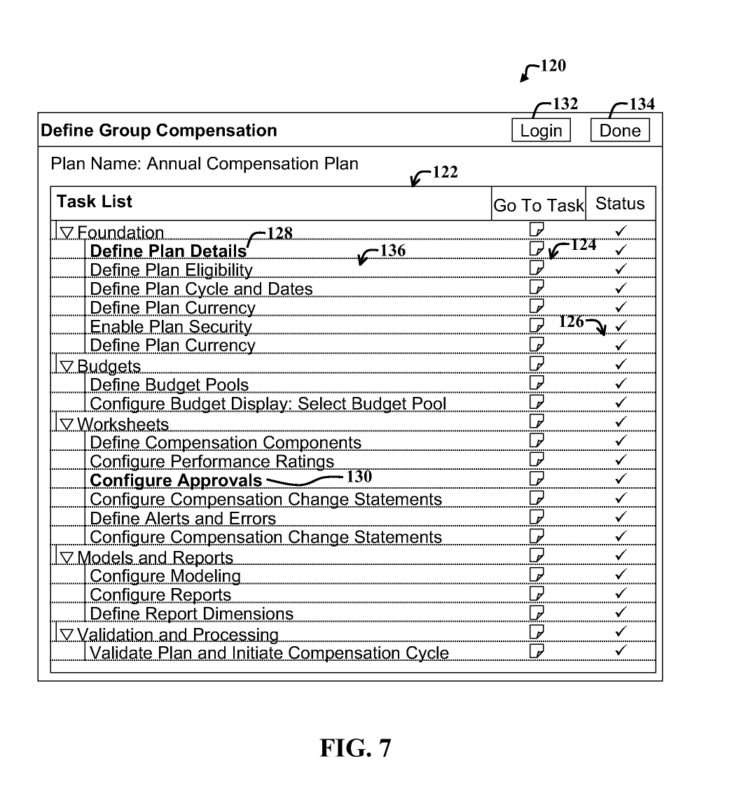

FIG. 7 is a first example display 120 that may be represented via the user interface modules 42, 24 of the system 10 of FIG. 1 and that lists certain configurable aspects 136 of an example compensation plan. The first example display 120 represents an example screenshot that may be produced via the GUI module 24 of FIG. 1. The first example display 120 includes a task list 122, which includes a first list of icons 124 corresponding to configuration categories 136 associated with a compensation plan, such as an annual compensation plan governing group compensation.

The first list of icons 124 represents controls for enabling enable a user to access additional displays, i.e., screens. The additional displays include additional controls for performing tasks associated with each of the configuration categories 136. The shown configuration categories 136 are for illustrative purposes. Additional or fewer configuration categories may be employed without departing from the scope of the present teachings. A list of status indicators 126 indicate whether a given configuration category has been accessed or otherwise addressed.

To access controls associated with teach configuration category 136, a user first logs in, such as by selecting a login button 124 and entering login information, such as username and password. The login information, which is associated with a set of access privileges or usage rights, is used to confirm the identity of the user and to enable appropriate access to the accompanying system and associated user interface controls. Note that a user may login via another control or another screen other than via just the login button 132 of FIG. 7 without departing from the scope of the present teachings. For example, before even seeing the task list 122, certain organizations may desire that a user first login. In this case, login functionality is provided before granting access to the task list 122.

In the present example display 120, before a user can access functionality associated with the icons 124, a user must log in. For illustrative purposes, a display screen displayed in response to an authorized user's selection of a task icon corresponding to “Define Plan Details” 128 and a display screen displayed in response to an authorized user's selection of a task icon corresponding to “Configure Approvals” 130 are discussed more fully below. A user may close the display screen 120 by selecting a “done” button 134.

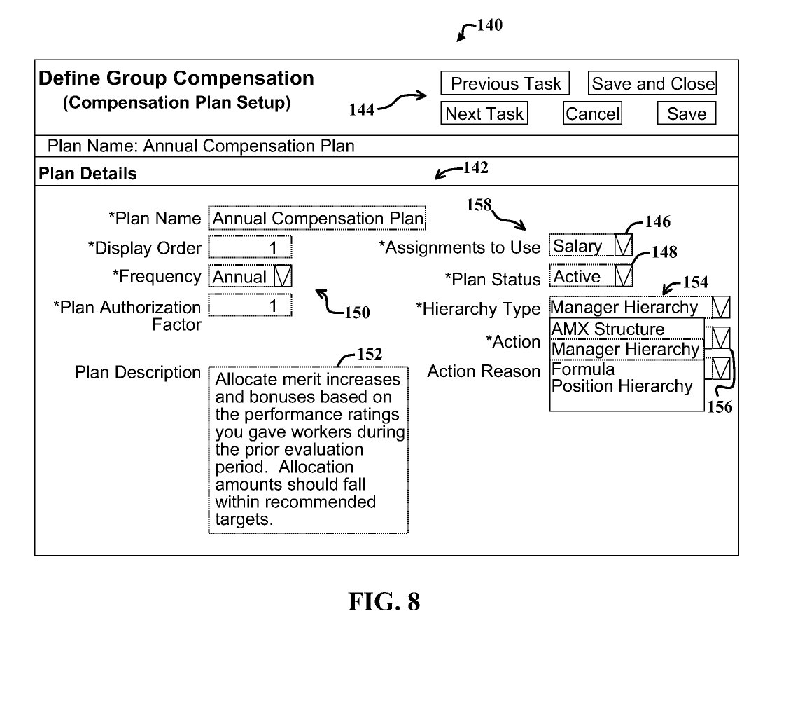

FIG. 8 is a second example display 140 for configuring example compensation-plan setup details, wherein the second example display 140 is accessible via the first example display 120 of FIG. 7. The second example display 140, also called the plan-details-setup screen, appears when an authorized user selects a go-to-task icon associated with “Define Plan Details” 128 in the task list 136 of FIG. 7.

The plan-details-setup screen 140 includes various navigation controls 144 for moving between configuration tasks, saving and closing, and canceling changes made via the screen 140. The plan-details-setup screen 140 includes a plan-details section 142, which includes various controls for characterizing a particular named plan. Example controls include descriptive controls 150, which provide mechanisms for specifying the name of a particular compensation plan, a frequency associated therewith, a plan description 152, and so on. Additional action controls 158 include a compensation-assignment control 146 for specifying the type of compensation to be used in the plan; a status control 148 for indicating a status of the plan, a hierarchy control 154 for selecting what type of hierarchy will pertain to the plan; and an action control 156 for specifying an action to be taken in accordance with the compensation plan.

The hierarchy control 154 facilitates selection of the reporting structure used to build worksheets, as discussed more fully below. This determines the workers that appear on each manager's worksheet and each manager's approval chain.

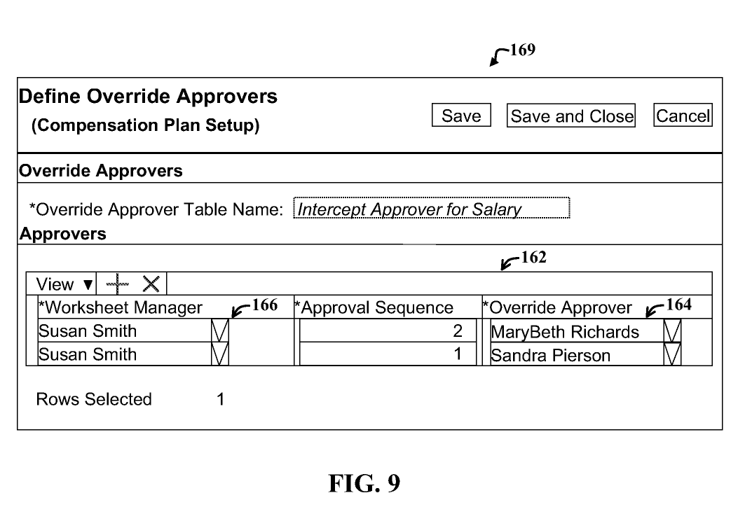

FIG. 9 is a third example display 160 for configuring override approvers for a compensation plan, wherein the third example display 160 is accessible via the first example display 120 of FIG. 7 by authorized users. The third example display 160, also called the override-approvers setup screen, includes various controls 162 for assigning override approvers 164 to corresponding managers 166. To access the override-approvers setup screen 160, an authorized manager first logs into the compensation hierarchy module 20 of FIG. 1.

In the present example override-approvers setup screen 160, a manager named Susan Smith is assigned two different override approvers. In particular, the override approvers are MaryBeth Richards and Sandra Pierson.

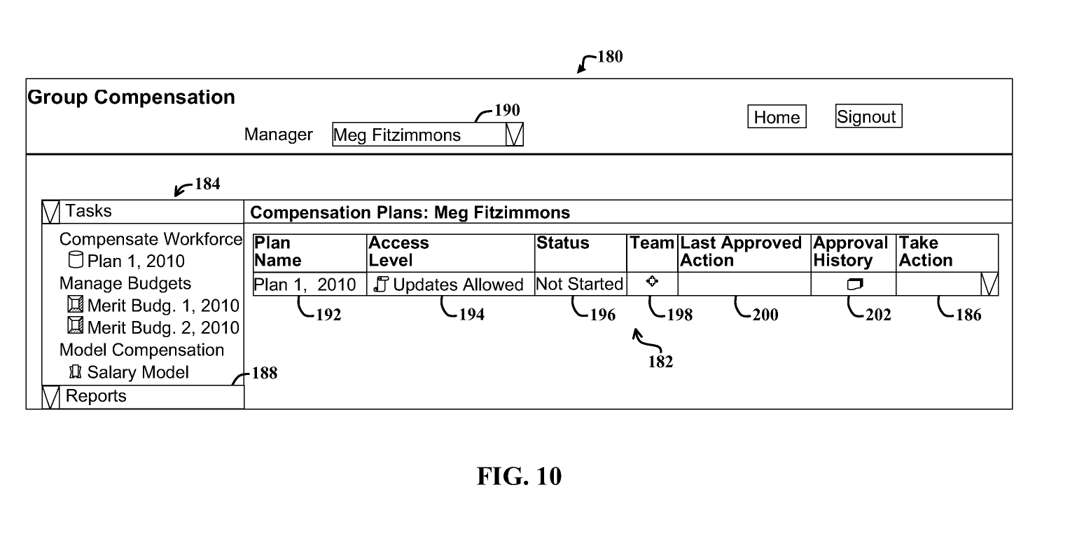

FIG. 10 is a fourth example display 180 listing available compensation plans 182 and accompanying controls and actions available to an authorized manager after login to the compensation module 20 of the system 10 of FIG. 1.

An authorized user may employ a task drop-down menu 184 to access various plans, budgets, or compensation models to work on. An authorized user may also access various reports via a reports control. The particular authorized user, i.e., manager in this case, is listed via a manager-selection control 190. In the present example, the manager Meg Fitzimmons is using a compensation plan called “Plan 1, 2010” to perform tasks, i.e., actions, pertaining to group compensation. A take-action control 186 provides drop-down menu functionality enabling the manager to access additional display screens with controls used to affect compensation and hierarchy positioning of subordinates of the manager, as discussed more fully below.

In the present example, the compensation plan “Plan 1, 2010” is associated with various additional descriptive fields, including a name field 192 indicating the name of the compensation plan; an access-level field 194 indicating whether updates are allowed to a compensation hierarchy pertaining to the compensation plan; a status field 196 indicating whether the compensation plan has been implemented or worked on; a team field 198 indicating a team associated with the compensation plan; a last-action-approved field 200 indicating a last approved action that was implemented in association with the compensation plan; and an approval-history field 202 providing access to a history of approvals of actions.

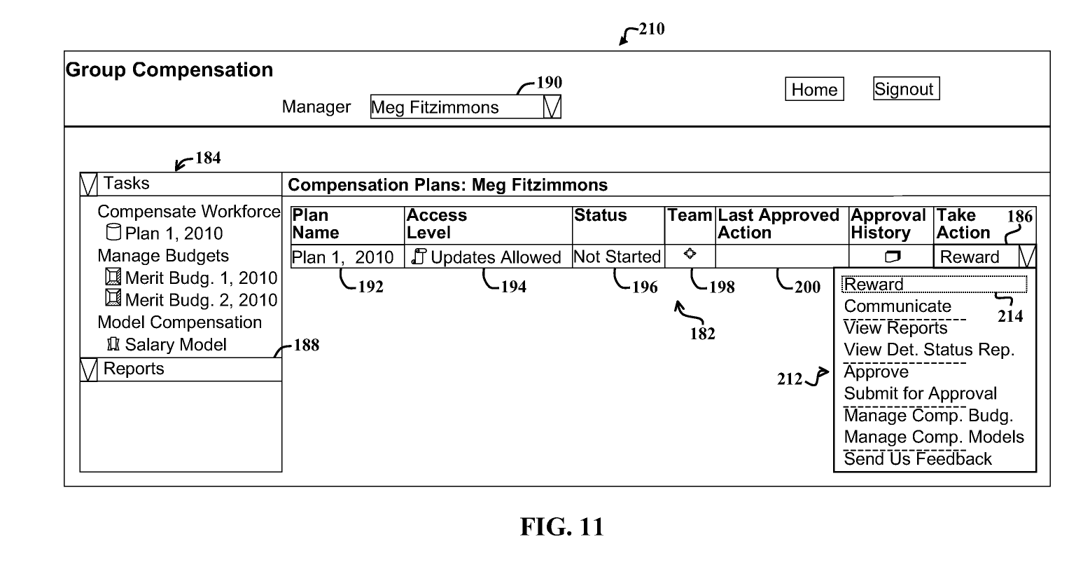

FIG. 11 is a fifth example display 210 illustrating example actions that may be taken by a manager via the fourth example display 180 of FIG. 10. The fifth example display 210 corresponds to the fourth example display 180 of FIG. 10, wherein the take-action control 186 has been activated to display an example drop-down menu 212. The drop-down menu 212 illustrates various options, including a “Reward” option 214. Upon selection of the reward option 214, an authorized user may access a worksheet whereby the user may adjust compensation and hierarchy positioning of subordinates, as discussed more fully below.

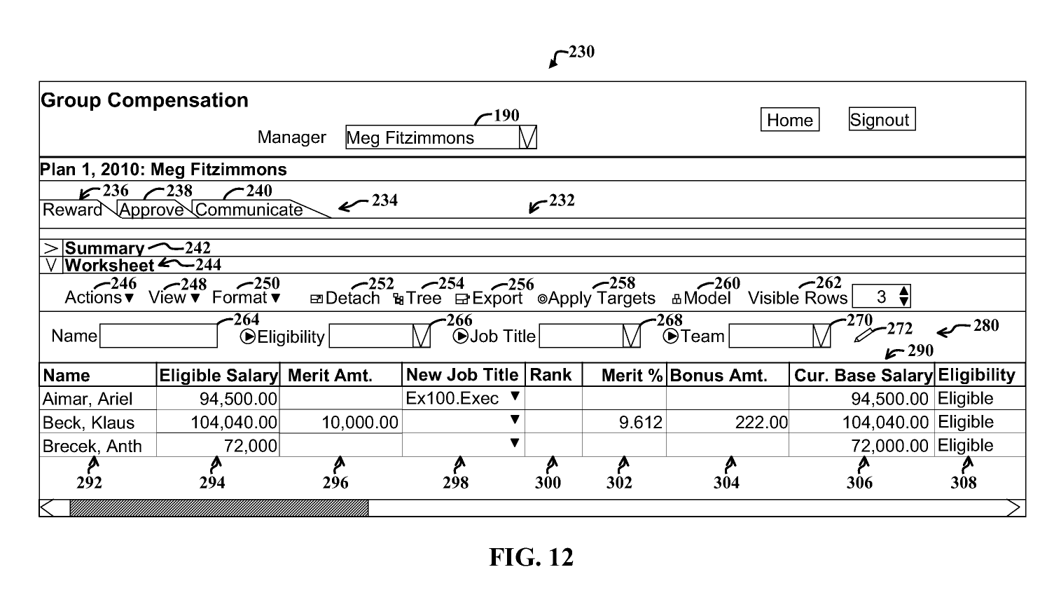

FIG. 12 is a sixth example display 230 illustrating an example worksheet 232 that may appear when an authorized manager selects to allocate rewards from the fifth example display 210 of FIG. 11. In present example, the manager Meg Fitzimmons has selected the reward option 214 from the drop-down menu 212 of FIG. 11 to display the worksheet 232 of FIG. 12.

The worksheet 232 includes various tabs 234, including a displayed reward tab 236, an approve tab 238, and a communicate tab 240. The approve tab 238 may be selected to access task-approval related information, such as listings as to which tasks have been approved, who has approved a particular task, when a task was approved, and so on. The communicate 240 may be employed to facilitate observing communications that have been propagated to various personnel in an accompanying organization or business pertaining to changes or updates made to the accompanying compensation hierarchy, including compensation changes and changes to the compensation hierarchy structure.

In the reward tab 236, a user may select a summary view 242 or the displayed worksheet view 244. The worksheet view 244 provides various controls, including an actions control 246 for performing various worksheet-related actions; a view control 248 for changing worksheet views; a format control 250 for adjusting worksheet format; a detach control 252 for selectively detaching the worksheet 244 into a separate dialog box; a tree control 254 for enabling viewing of a hierarchy tree, such as a hierarchy tree similar to the hierarchy 70 shown in FIG. 3; an export control 256 for exporting data from the worksheet 244; an apply-targets control 258 for facilitating an implementing targets or goals; a model control 260 for adjusting compensation models used; and a visible-rows control 262 for adjusting the number of rows displayed in the worksheet 244.

The worksheet 244 further includes various additional fields and tools 280, which may be used to filter subordinates listed in an accompanying table 290. The additional fields 280 include a name field 264, which can be used to find a particular worker, i.e., subordinate; an eligibility field 206 for filtering the table 290 in accordance with eligibility; a job-title field 268 for filtering the table 290 in accordance with a particular job title; a team field 270 for filtering the table 290 by team; and a note tool 272 for enabling note taking on the worksheet table 290.

The worksheet table 290 includes a name column 292 that lists names of various subordinates of the manager accessing the display screen 230, i.e., Meg Fitzimmons. An eligible-salary column 294 lists salaries that corresponding subordinates are eligible to receive. A merit amount column 296 lists any merit amounts being awarded to a corresponding subordinate. A New-job-title column 298 provides controls for changing the job title of a subordinate. A rank column 300 provides an area whereby a manager may provide a ranking number to a subordinate. A merit percent column 302 provides fields whereby a manager may assign merit percentages to a subordinate. A bonus-amount field 304 provides fields whereby a manager may allocate observe or change a bonus amount allotted to a given subordinate. A current-base-salary field 306 indicates the current salary that a particular subordinate is being paid. An eligibility column 308 includes fields indicating whether a corresponding subordinate is eligible for salary changes.

Note that more or fewer controls, fields, and/or functionality may be accessed from a given user interface display screen than those shown in the figures, such as FIG. 12, without departing from the scope of the present teachings.

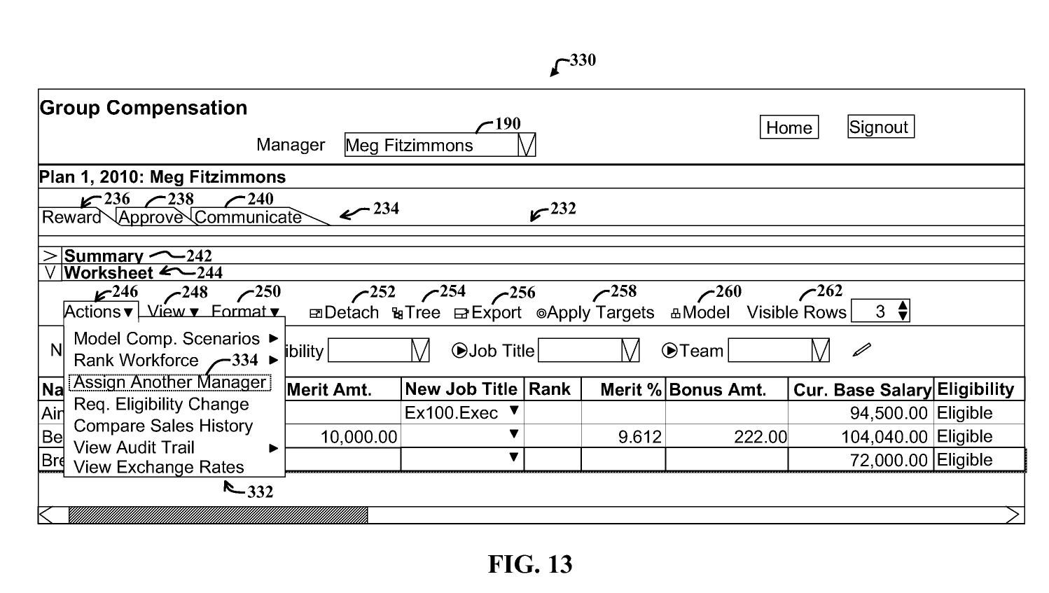

FIG. 13 is a seventh example display 330 illustrating example actions that may be taken or triggered by a manager via the sixth example display 230 of FIG. 12. The sixth example display 330 corresponds to the second example display 230 after the action control 246 has been selected, thereby causing display of a second action drop-down menu 332.

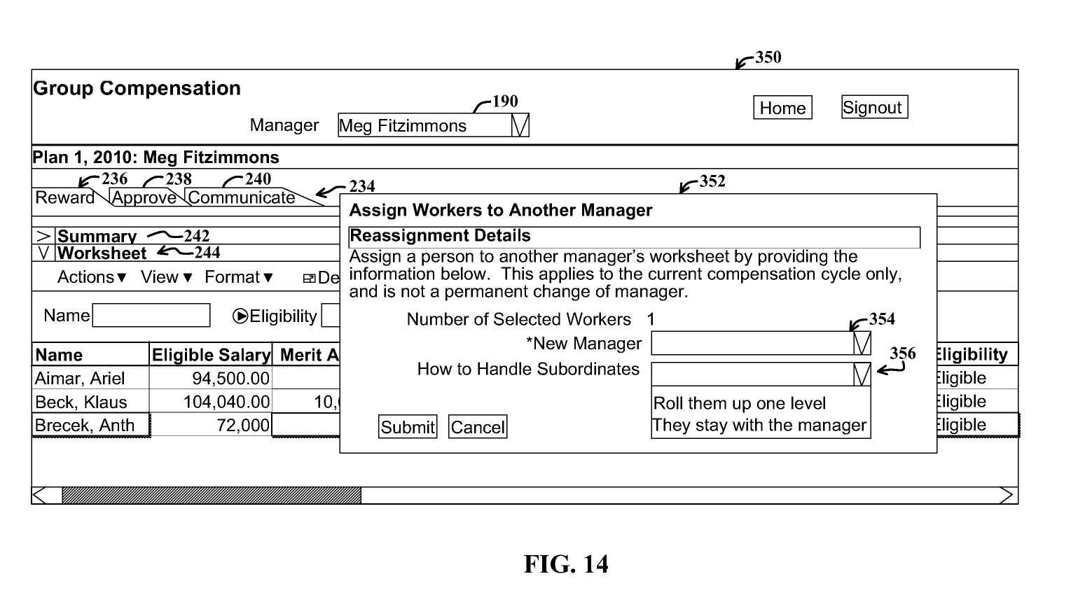

The second action drop-down menu 332 provides various additional controls that provide access to additional dialog boxes or display screens to facilitate implementing particular tasks. For example, a manager may select “Assign Another Manager” 334 from the drop-down menu 332 to facilitate assigning a subordinate to be a subordinate of another subordinate manager. Upon selection of “Assign Another Manager” 334, a dialog box with additional controls for facilitating adjusting the compensation hierarchy appears, as discussed more fully below with reference to FIG. 14.

FIG. 14 is an eighth example display 350 illustrating an example dialog box 352 that appears when a manager chooses to assign a worker to another manager via the seventh example display 330 of FIG. 13.

The manager performing the reassignment first selects one or more subordinates to reassign to another manager. In the present example, Anth Brecek is selected before the “Assign Another Manager” option 344 is selected from the seventh display 330 of FIG. 13.

The resulting dialog box 352 indicates the number of workers, i.e., subordinates that have been selected; provides new-manager field 354 for enabling selection of a new manager; and provides a handling control 356 for enabling specification as to how the subordinates of the worker are to be repositioned in the hierarchy. In the present example, the subordinates may be moved up one level, i.e., the hierarchy is collapsed or compacted as discussed above with reference to FIGS. 4-5, or the subordinates may remain reporting to the subordinate that is being moved, as discussed above with reference to FIGS. 3-4.

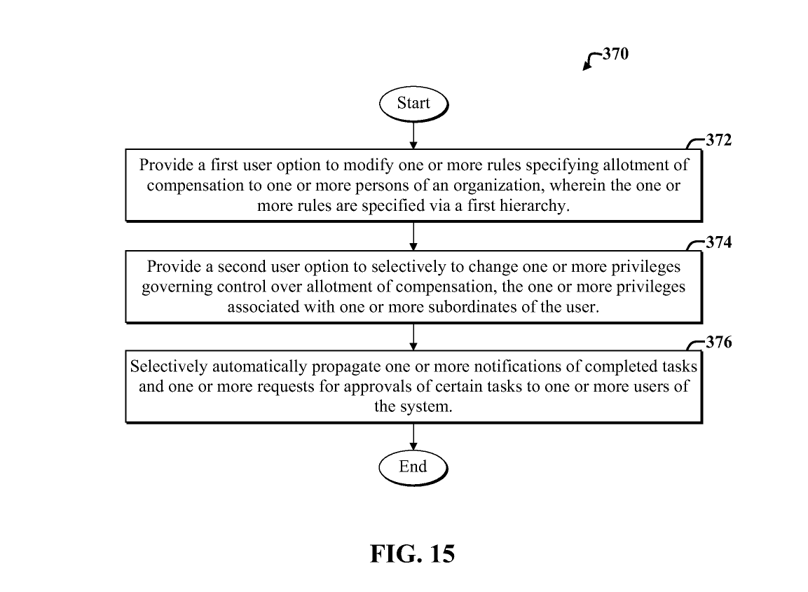

FIG. 15 is a flow diagram of a second example method 370 adapted for use with the system 10 of FIG. 1 and the user interface displays of FIGS. 7-14.

The second example method 370 includes a first step 372 that involves providing a first user option to modify one or more rules specifying allotment of compensation to one or more persons of an organization. The one or more rules characterize via a first compensation hierarchy.

A second step 374 includes providing a second user option to selectively to change one or more privileges governing control over allotment of compensation. The one or more privileges are afforded to one or more subordinates of the user. For example, the change in the one or more privileges may coincide with a corresponding change of positioning within a compensation hierarchy. When a worker's position in a hierarchy is adjusted, the worker's supervisory privileges with respect to other workers, such as superiors and/or subordinates may change. In the present specific embodiment, privileges afforded to a subordinate that govern control over allotment of compensation include authority to adjust salary or other compensation provided to a subordinate and the ability to control the chain of command of subordinates.

A third step 376 includes selectively automatically propagating one or more notifications of completed tasks and one or more requests for approvals of certain tasks to one or more users of the system. The propagating of such information is facilitated by, for example, the communicate tab 240 and the approve tab 238 of the communicate tab 240 of the worksheet 232 of FIG. 13.

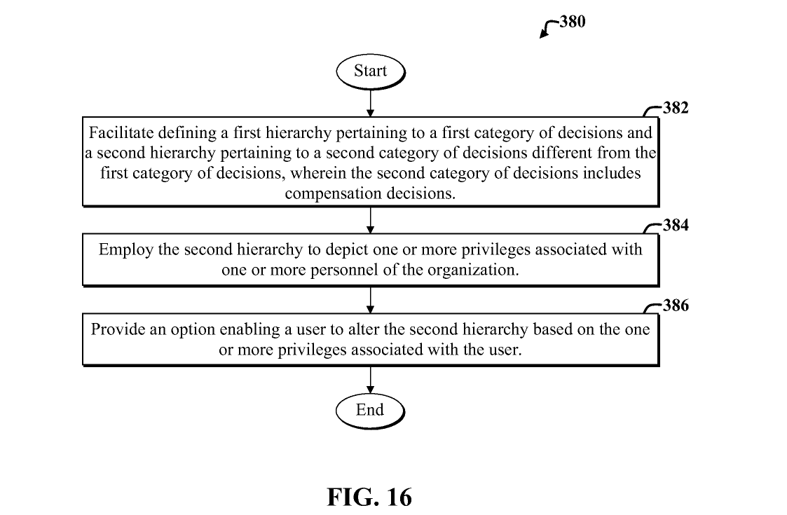

FIG. 16 is a flow diagram of a third example method 380 adapted for use with the system 10 of FIG. 1 and the user interface displays of FIGS. 7-14. The third example method 380 includes a hierarchy-defining step 382, which involves facilitating defining a first hierarchy pertaining to a first category of decisions and a second hierarchy pertaining to a second category of decisions different from the first category of decisions, wherein the second category of decisions includes compensation decisions. In the present example embodiment, the first category of decisions may correspond to HR decisions other than compensation-related decisions.

A subsequent using step 384 includes employing the second hierarchy to depict one or more privileges associated with one or more personnel of the organization.

Next, a providing step 386 includes providing a user option to enable a user to alter the second hierarchy in accordance with the one or more privileges associated with the user.

Hence the present method involves implementing dual parallel hierarchies, where at least of the hierarchies includes a compensation hierarchy, and where an authorized user may modify the compensation hierarchy, such as by moving representations of subordinates within the compensation hierarchy structure; by adjusting allotments of compensation in accordance with a corresponding compensation plan; by adding intercept approvers to certain tasks of a subordinate, and so on.

Note that the methods of FIGS. 15 and 16 are merely illustrative and may be altered without departing from the scope of the present teachings. For example, certain steps may be rearranged, omitted, and/or additional steps or details may be added. For example, with reference to the method 380 of FIG. 16, the method may further include providing an option to select or change intercept approvers; providing an option to adjust compensation of a subordinate; providing an option to alter positioning of representations subordinates within a hierarchy structure, and so on.

The various embodiments described herein may be adapted to run on various processing systems, such as one or more computers. A data storage device, such as hard drive, may accommodate storage of data in the databases and/or storage of computer readable instructions for implementing various functionality described herein.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a processor-readable storage medium or device for use by or in connection with an instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means. It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for modifying a workplace decision-making hierarchy, the method comprising the following acts performed by a digital processor coupled to a display:
displaying a first hierarchy on the display;
providing a first user option to modify one or more rules specifying allotment of compensation to one or more persons of an organization, wherein the one or more rules are specified via the first hierarchy;
providing a second user option to selectively change one or more privileges governing control over allotment of compensation, the one or more privileges associated with one or more subordinates of the user; and
selectively automatically propagating one or more notifications of completed tasks and one or more requests for approvals of certain tasks to one or more users of the system.

2. The method of claim 1, wherein the one or more users of the system include one or more intercept approvers.

3. The method of claim 1, wherein the user includes one or more business line managers.

4. The method of claim 1, further including selectively modifying the hierarchy to selectively allot one or more compensation-allocation privileges to one or more persons within the organization that have one or more subordinates working therefor.

5. The method of claim 4, wherein the one or more compensation-allocation privileges include a privilege of a user to change salary allocation to a subordinate thereof.

6. The method of claim 4, wherein the one or more compensation-allocation privileges include a privilege of a user to change bonus allocation to a subordinate thereof.

7. The method of claim 4, wherein the one or more compensation-allocation privileges include a privilege of a user to change stock allocation to a subordinate thereof.

8. The method of claim 4, wherein the one or more compensation-allocation privileges include a privilege of a user to change a role of a subordinate thereof by promoting, firing, or demoting the subordinate.

9. The method of claim 1, further including selectively moving a hierarchy representation of first manager to a different position in the hierarchy, wherein the hierarchy representation of the first manager has one or more hierarchy representations of subordinates reporting thereto.

10. The method of claim 9, further including providing a user option to collapse a portion of the hierarchy, whereby the collapsed hierarchy represents that personnel reporting to the first manager to now report to a second manager, wherein a hierarchy representation of the second manager is characterized by a similar level in the hierarchy as the hierarchy representation of the first manager.

11. The method of claim 9, further including automatically sending information indicating one or more changes to the hierarchy to one or more users of the system.

12. The method of claim 11, wherein the automatic sending includes communicating a request for authorization of a task performed by a manager from a superior of the manager.

13. The method of claim 11, wherein the automatic sending includes communicating a request for authorization of a task performed by a manager from a predetermined intercept approver associated with the task.

14. The method of claim 1, further including implementing the first hierarchy simultaneously with one or more additional hierarchies.

15. The method of claim 14, wherein the one or more additional hierarchies are associated with one or more separate compensation plans.

16. The method of claim 14, wherein the one or more additional hierarchies include a hierarchy governing human resources tasks that include tasks other than assignment or adjustment of compensation.

17. The method of claim 1, further including controlling visibility of different portions of the hierarchy by one or more users of a hierarchy system that implements the method, wherein the visibility is determined in accordance with one or more privileges associated with the one or more users of the system.

18. The method of claim 17, further including providing a log-in mechanism to facilitate controlling display of a particular portion of the hierarchy to a user in accordance with one or more privileges of the user, wherein the one or more privileges are defined via the hierarchy.

19. An apparatus for modifying a workplace decision-making hierarchy, the apparatus comprising:
a digital processor coupled to a display and to a processor-readable storage device, wherein the processor-readable storage device includes one or more instructions executable by the digital processor to perform the following acts:
displaying a first hierarchy on the display;
providing a first user option to modify one or more rules specifying allotment of compensation to one or more persons of an organization, wherein the one or more rules are specified via the first hierarchy;
providing a second user option to selectively to change one or more privileges governing control over allotment of compensation, the one or more privileges associated with one or more subordinates of the user; and
selectively automatically propagating one or more notifications of completed tasks and one or more requests for approvals of certain tasks to one or more users of the system.

20. A processor-readable storage device including instructions executable by a digital processor for modifying a workplace decision-making hierarchy, the processor-readable storage device including one or more instructions for:
displaying a first hierarchy on a display;
providing a first user option to modify one or more rules specifying allotment of compensation to one or more persons of an organization, wherein the one or more rules are specified via the first hierarchy;
providing a second user option to selectively to change one or more privileges governing control over allotment of compensation, the one or more privileges associated with one or more subordinates of the user; and
selectively automatically propagating one or more notifications of completed tasks and one or more requests for approvals of certain tasks to one or more users of the system.
